(19) United States
(12) Patent Application Publication
(10) Pub. No.: US 2010/0164839 A1
(43) Pub. Date: Jul. 1, 2010

(54) PEER-TO-PEER DYNAMICALLY APPENDABLE LOGICAL DISPLAYS

(76) Inventors: Kenton M. Lyons, San Jose, CA (US); Roy Want, Los Altos, CA (US); Trevor A. Pering, San Francisco, CA (US)

Correspondence Address: Ryder, Lu, Mazzeo and Konieczny, LLC;C/O CPA Global, P. O. BOX 52050, MINNEAPOLIS, MN, 55402, US

(21) Appl. No.: 12/347,708

(22) Filed: Dec. 31, 2008

(51) Int. Cl. G09G 5/00

(52) U.S. Cl. 345/2.3

(57) ABSTRACT

In general, in one aspect, the disclosure describes an apparatus that includes memory to store application window images of applications running thereon and a composite display generator to generate a composite display based on at least some of the application window images stored in the memory and any application window images received from other wireless devices. The apparatus may also include a remote display to transmit at least some of the application window images stored in the memory to the other wireless devices. The apparatus may include a frame buffer to store the composite display and a display to display the composite display stored in the frame buffer. The apparatus may include a communication interface to establish wireless communication links with the other wireless devices. Other embodiments are described and claimed.

### BACKGROUND

The use of wireless devices (e.g., portable computers, personal digital assistants (PDAs), cellular phones) is growing exponentially. Many wireless devices include a display having a relatively small display area. The display area may not be big enough to allow for convenient viewing of relatively large images (e.g., a large architectural blueprint, a spreadsheet having a large number of rows and/or columns). The display area may also not be large enough to view various items at one time.

### BRIEF DESCRIPTION OF THE DRAWINGS

The features and advantages of the various embodiments will become apparent from the following detailed description in which:

FIG. 1 illustrates a block diagram of an example system having a wireless device providing an image over displays of multiple wireless devices, according to one embodiment;

FIG. 2 illustrates an example system implementing peer-to-peer window compositing to create an augmented display, according to one embodiment; and

FIG. 3 illustrates an example functional block diagram of a wireless device utilized for peer-to-peer window compositing to create an augmented display, according to one embodiment.

### DETAILED DESCRIPTION

In order to expand the display area available to wireless devices, wireless devices in close proximity to, and communicating with, one another can append their displays in order to create a larger display therebetween. The larger display, made up of individual displays, can be utilized to view relatively large images (e.g., a large architectural blueprint, a spreadsheet having a large number of rows and/or columns) that can not be conveniently viewed on a display of a single wireless device (host device) having the image contained therein. One of the wireless devices may become a host device that presents its content over the displays of multiple wireless devices. The host device may dynamically expand the amount of memory allocated to the display frame buffer so that the frame buffer is greater than the area being serviced by the display controller delivering an image to the host display (physical frame buffer). When another wireless device is located nearby (client display), the host device may place a portion of the image in a portion of the frame buffer not designated for the host display and associate it with the client display (logical frame buffer). The host device may then remotely drive the client display to display the portion of the image from the logical frame buffer using remote frame buffer (RFB) protocols.

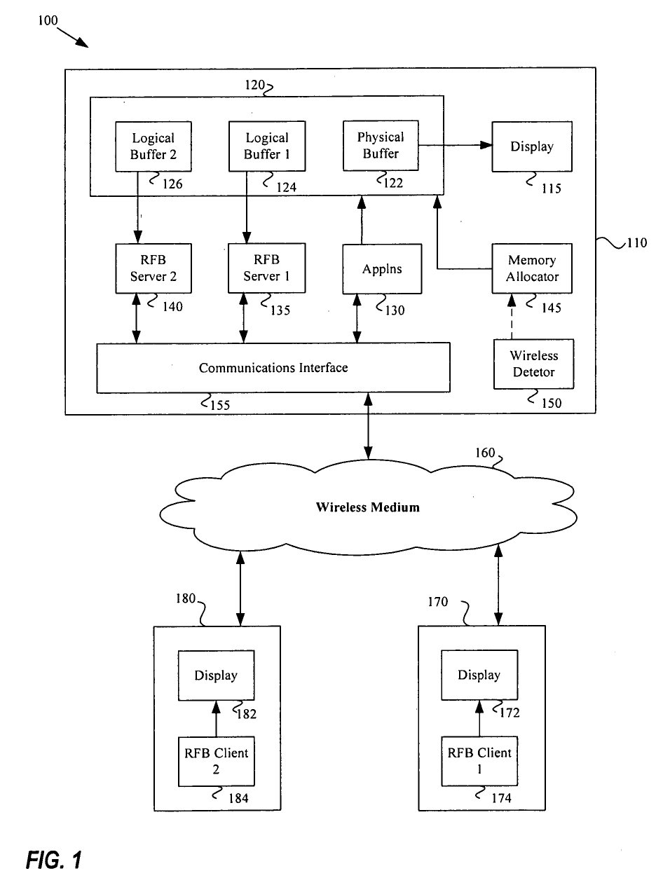

FIG. 1 illustrates a block diagram of an example system 100 wherein a wireless device is providing an image over displays of multiple wireless devices. The system 100 may include a host wireless device 110, a wireless medium 160, and a plurality of client wireless devices (first and second client wireless devices 170, 180 are illustrated). The wireless devices 110, 170, 180 may be, for example, laptop computers, tablet computers, personal digital assistants (PDA), cellular phones, or some combination thereof. The wireless medium 160 may be a wireless network, for example, a wireless local area network (WLAN) such as that compliant with IEEE standard 802.11.x (WiFi), a wireless metropolitan area network (WMAN) such as that compliant with the IEEE standard 802.16.x (WiMAX), or a wireless personal area network (WPAN) such as that compliant with the Bluetooth core specification version 2.0 with enhanced data rate (Bluetooth).

The host wireless device 110 may include a display 115, a frame buffer 120, one or more applications 130, one or more RFB server applications (first and second RFB servers 135, 140 illustrated), a memory allocator 145, a wireless detector 150, and a communication module 155. The display 115 is to display information associated with the application(s) 130 running thereon, the images which have been stored in the frame buffer 120. The application(s) 130 may include, for example, any application capable of presenting content to the user of the host wireless device 110. The application 130 may be capable of rendering content that is designed for presentation on an area larger than the display 115.

The frame buffer 120 is to buffer display information for the content generated by applications 130. The frame buffer 120 may include a physical frame buffer 122 to buffer display information (e.g., pixels) for content to be displayed on the display 115 and one or more logical frame buffers (first and second logical frame buffers 124, 126 illustrated) to buffer display information (e.g., pixels, commands necessary to generate the pixels, display geometry and relative positioning) for the client wireless devices (e.g., 170, 180). The memory allocator 145 is to dynamically expand the frame buffer 120 to include the logical frame buffers (e.g., 124, 126). The frame buffer 120 may be expanded for client wireless devices available to be utilized (e.g., in close proximity and capable of displaying remote content).

The memory allocator 145 may expand frame buffer 120 based on number and size of the client displays available. The memory allocator 145 may expand the frame buffer 120 to include logical frame buffers 124, 126 to buffer display information (e.g., pixels, commands, geometry) for content to be displayed on displays for client wireless devices 170, 180. The content to be displayed on the client displays may be contiguous (e.g., above, below) with the content to be displayed on the host display or the content to be displayed on other client displays. It should be noted that while the logical frame buffers 124, 126 may contain a viewpoint of the image that would appear to be continuous with the viewpoint of the image in physical frame buffer 122 or the other logical frame buffers 124, 126 the actual memory locations may be remote from each other.

The wireless detector 150 may detect one or more wireless devices (e.g., 170, 180) that are in close proximity of the wireless device 110. The wireless detector 150 may inform the user of the wireless device 110 that additional wireless devices are available. The wireless detector 150 may establish a wireless communication link with the wireless devices and may be able to determine if the other wireless devices in close proximity are capable of receiving content from the wireless device 110 and displaying the content on their display (if the wireless devices are client wireless devices (e.g., 170, 180)). The wireless detector 150 may provide the user with information only for those wireless devices that can be utilized to expand the display area (the client wireless devices 170, 180). The wireless detector 150 may provide an icon for each of the wireless devices 170,180 available and the user may select the icon if they wish to engage the wireless device 170, 180. The presentation of the information regarding the available wireless devices 170, 180 and the selection of the wireless devices 170, 180 is in no way limited to the presentation and selection of icons. Rather, any means of presenting information regarding the available wireless devices 170, 180 and any means for selecting from the available wireless devices 170, 180 is within the current scope.

The wireless detector 150 may provide information regarding the client wireless devices 170, 180 selected by the user to the memory allocator 145. The memory allocator 145 may allocate memory to the client wireless device 170, 180 (create logical frame buffer 124, 126) based on static parameters (e.g., size) related to the client displays. The memory allocator 145 may prompt the user for configuration data regarding the location of the logical frame buffers 124, 126 with respect to the physical frame buffer 122. If the client devices 170, 180 and the host device 110 have previously interacted and been used to create a larger display the memory allocator 145 may reconfigure the frame buffer 120 to how it was previously configured. The user may be able to override the previous configuration.

The RFB servers 135, 140 are to transfer the display information from the logical frame buffers 124, 126 to the wireless devices 170, 180. The RFB servers 135, 140 may be associated with specific client devices 170, 180 and establish a communication link therewith. The RFB servers 135, 140 may include any suitable application, program and/or protocol capable of monitoring the logical frame buffers 124, 126 to detect a change in the display information (e.g., pixels, commands, geometry) buffered therein, and upon detecting a change in the display information, to transfer the display information (e.g., in a compressed format) to the wireless devices 170, 180. For example, the RFB servers 135, 140 may be a Virtual Network Computing (VNC) application or X-Windows applications.

The communications interface 155 may provide the communications between the host wireless device 110 and the client wireless devices 170, 180 over the wireless medium 160. The communications interface 155 may include network adapter(s) necessary to interface with the wireless medium 160. The communications interface 155 may also provide communications over the Internet and may include network adapter(s) for communicating therewith.

The client wireless devices 170, 180 may include displays 172, 182 and RFB client applications 174, 184. The displays 172, 182 are for displaying content (either local content or content presented remotely from a host wireless device). The RFB clients 174, 184 may provide images to the displays 172, 182 based on the display information received from the RFB servers 135, 140. If the display information received from the RFB servers 135, 140 was pixels the RFB clients 174, 184 may display the pixels on the displays 172, 182. If the display information received from the RFB servers 135, 140 was commands the commands may be utilized to generate pixels and the generated pixels may be presented on the displays 172, 182. The RFB clients 174, 184 may be running any number of RFB applications including a VNC application.

The image displayed by displays 115, 172, 182 may be a contiguous image so that the plurality of displays 115, 172, 182 appear to be one display.

The system 100 while enabling the appending of displays of wireless devices to create a larger display area requires the host device 110 to act as the server to host the frame buffer for all the client devices 170, 180. In this arrangement, any application that wanted to utilize the expanded display area may need to run from the host device 110. If one of the client devices (e.g., 170) wanted to host an application and utilize the extended display area it would need to operate as a second server and create an independent virtual frame buffer and all of the other devices (e.g., 110, 180) would have to connect to that device. Utilizing a wireless device as a server may also cause the server to become a bottle neck since it must host requests from all of the connected client devices.

In order to avoid the issues noted above with regard to the host device 110 acting as a server the wireless devices may be implemented in a peer-to-peer arrangement. In a peer-to-peer arrangement instead of remoting an entire virtual frame buffer from a host device to the various client devices, each individual application renders their application windows locally, and individual application windows can be shared with remote devices. Using this new technique, applications can be hosted on any device and sent remotely to any other devices, removing the need for a centralized server.

Each wireless device may have a compositing windowing system (e.g., Apple's X operating system (OS), Microsoft's Vista OS). Compositing windowing systems render each application into main memory (application window regions) and then utilize pixels from potentially several applications to generate a composited display. The composited display is placed into the display's frame buffer for presentation on the display. The composited display enables a user to create window effects and animations and to support window transparency, among other things. The compositing windowing system may be augmented to support peer-to-peer connections with the other wireless devices and use pixels from the application window regions of other devices in the composited local display. This enables the application window regions that would otherwise not be shown on the device's local screen to be transported to other devices for display. A remote display (RD) protocol may be utilized to transmit display information (e.g., pixels, commands necessary to generate the pixels, display geometry and relative positioning) regarding the application window regions from one device to another device.

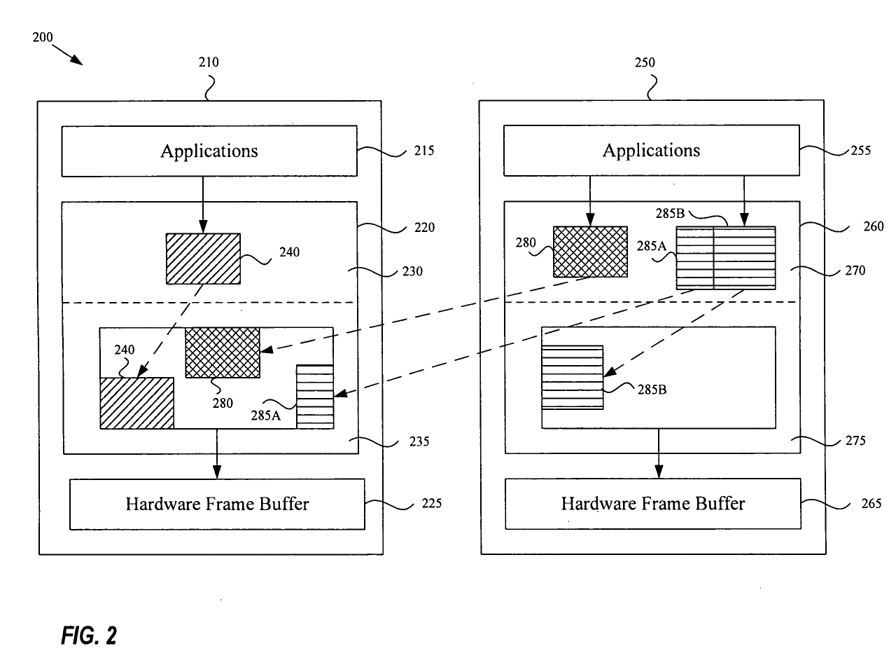

FIG. 2 illustrates an example system 200 implementing peer-to-peer window compositing to create an augmented display. The system 200 includes a plurality of wireless devices (first and second wireless device 210, 250 illustrated). The wireless devices 210, 250 may communicate with each other via a wireless medium (not illustrated). The wireless devices 210, 250 may include applications 215, 255, peer-to-peer composition window systems 220, 260 and hardware frame buffers 225, 265. The peer-to-peer composition window systems 220, 260 may include an application rendering portion 230, 270 and a composited local display portion 235, 275. The application rendering portion 230, 270 may be memory storing the images displayed by each of the applications 215, 255. The composited local display potion 235, 275 may contain pixels from one of more application to create the image to be displayed.

The applications 215 may generate an application window region 240. The application window region 240 may be placed within the composited window display 235 for presentation on the display (not illustrated) associated with the wireless device 210. As illustrated, the application window region 240 is located in a lower left portion of the composited window display 235. The applications 255 may generate an application window region 280 and an application window region 285. The application region 285 may be divided in two 285A, 285B. The application window region 285B may be placed within the composited window display 275 for presentation on the display (not illustrated) associated with the wireless device 250. As illustrated, the application window region 285B is located on left side of the composited window display 275. The window region 280 and the application window region 285A may be transferred to the composited window display 235. As illustrated, the application window region 285A is located in the lower right corner of the composited window display 235 and the window region 280 is located in the upper center of the composited window display 235. The composited window display 235 includes application window regions from both devices 210, 250.

The peer-to-peer composition window systems 220, 260 enable application window regions that would otherwise not be shown on the device's local screen to be transported to other devices for display. The peer-to-peer composition window systems 220, 260 also enable a display to receive portions of windows sent to it from other devices for local rendering. Taken together, this allows any screen element (such as a window) to be grown beyond the physical size of the local display onto other displays creating the effect of one large unified display surface. Alternatively, an individual window can be moved completely “off screen” and completely shown on another device.

By having the same peer-to-peer composition window systems 220, 260 run on all devices, any application from any of the connected devices can utilize this feature. In addition to supporting the ability to send and receive portions of applications' displays, there must be synchronization between window managers to enable coordinated cross display window manipulation (e.g., movement, maximization, minimization), a unified window stacking order, and a reconciliation of input events (e.g. from keyboards, mice, touch-screens).

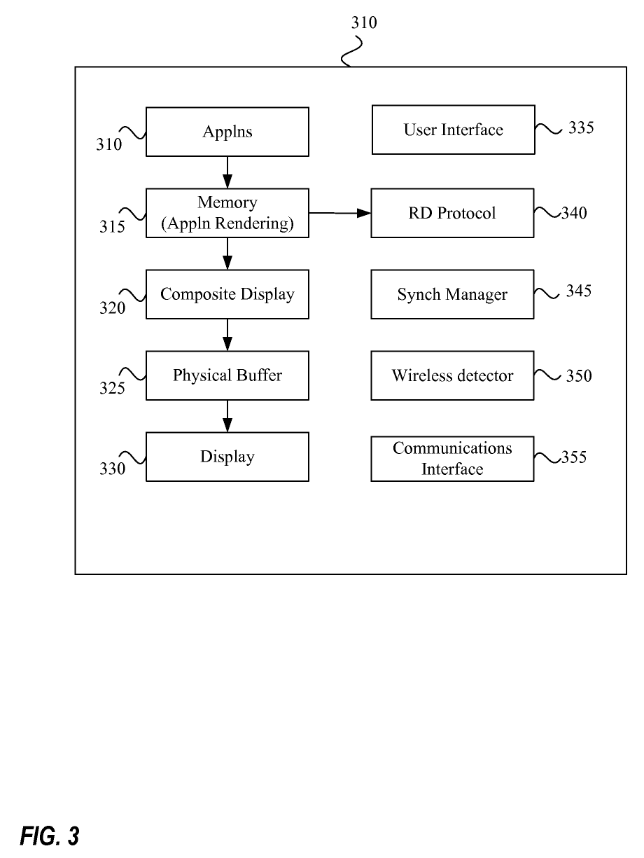

FIG. 3 illustrates an example functional block diagram of a wireless device 300 utilized for peer-to-peer window compositing to create an augmented display. The device 300 may include application(s) 310 running thereon, memory 315 for application rendering, a composite display generator 320, a frame buffer 325, a display 330, user interface(s) 335, an RD protocol 340, a synchronization manager 345, a wireless detector 350 and a communications interface 355.

The applications 310 may be capable of rendering content that can be displayed to the user. The content may be any size and/or shape. The applications 310 may render application window regions and these regions may be stored in the memory 315. The composite display generator 320 may utilize the application window regions (e.g., pixels) stored in the memory 315 and generate a composite display image therefrom. The composite display generator 320 may also receive application window regions (e.g., pixels, commands, geometry) from other wireless devices and may generate the composite display based on some combination of the images received and the images in memory 315.

The frame buffer 325 may buffer the composite display for presentation to the display 330. The user interface 335 may enable the user to interact with the device 300 and move content between the displays forming the appendable display. The user interface 335 may be, for example, a mouse, keyboard, or a touch screen. The RD protocol 340 may be utilized to transfer some of the application window regions (e.g., pixels, commands, geometry) to the composite display generator 320 of other wireless devices 300. The synchronization manager 345 may provide the synchronization between window managers to enable coordinated cross display window manipulation. The synchronization manager 345 may also provide a unified window stacking order and a reconciliation of user inputs.

The wireless detector 350 may detect other wireless devices that may be capable of being utilized in the appendable display. The communications interface 355 may provide the wireless linkage between the wireless devices.

Some embodiments, for example, may take the form of an entirely hardware embodiment, an entirely software embodiment, or an embodiment including both hardware and software elements. Some embodiments may be implemented in software, which includes but is not limited to firmware, resident software, microcode, or the like.

Furthermore, some embodiments may take the form of a computer program product accessible from a computer-usable or computer-readable medium providing program code for use by or in connection with a computer or any instruction execution system. For example, a computer-usable or computer-readable medium may be or may include any apparatus that can contain, store, communicate, propagate, or transport the program for use by or in connection with the instruction execution system, apparatus, or device.

In some embodiments, the medium may be an electronic, magnetic, optical, electromagnetic, infrared, or semiconductor system (or apparatus or device) or a propagation medium. Some demonstrative examples of a computer-readable medium may include a semiconductor or solid state memory, magnetic tape, a removable computer diskette, a random access memory (RAM), a read-only memory (ROM), a rigid magnetic disk, and/or an optical disk. Some demonstrative examples of optical disks include compact disk-read only memory (CD-ROM), compact disk-read/write (CD-R/W), and DVD.

In some embodiments, a data processing system suitable for storing and/or executing program code may include at least one processor coupled directly or indirectly to memory elements, for example, through a system bus. The memory elements may include, for example, local memory employed during actual execution of the program code, bulk storage, and cache memories which may provide temporary storage of at least some program code in order to reduce the number of times code must be retrieved from bulk storage during execution.

In some embodiments, input/output or I/O devices (including but not limited to keyboards, displays, pointing devices, etc.) may be coupled to the system either directly or through intervening I/O controllers. In some embodiments, network adapters may be coupled to the system to enable the data processing system to become coupled to other data processing systems or remote printers or storage devices, for example, through intervening private or public networks. In some embodiments, modems, cable modems and Ethernet cards are demonstrative examples of types of network adapters. Other suitable components may be used.

Although the disclosure has been illustrated by reference to specific embodiments, it will be apparent that the disclosure is not limited thereto as various changes and modifications may be made thereto without departing from the scope. Reference to “one embodiment” or “an embodiment” means that a particular feature, structure or characteristic described therein is included in at least one embodiment. Thus, the appearances of the phrase “in one embodiment” or “in an embodiment” appearing in various places throughout the specification are not necessarily all referring to the same embodiment.

The various embodiments are intended to be protected broadly within the spirit and scope of the appended claims.

What is claimed is:

1. An apparatus comprising:
memory to store application window regions of applications running thereon; and
a composite display generator to generate a composite display based on at least some of the application window regions stored in the memory and any application window regions received from other wireless devices.

2. The apparatus of claim 1, further comprising a remote display protocol to transmit display information regarding at least some of the application window regions stored in the memory to the other wireless devices, wherein the other wireless devices are in close proximity and capable of appending their displays to create a larger display area.

3. The apparatus of claim 1, further comprising a frame buffer to store the composite display.

4. The apparatus of claim 3, further comprising a display to display the composite display stored in the frame buffer.

5. The apparatus of claim 1, further comprising a communication interface to establish wireless communication links with the other wireless devices.

6. The apparatus of claim 1, further comprising a detector capable of detecting the other wireless devices.

7. The apparatus of claim 1, wherein the composite display generator is to receive display information regarding application window regions from the other wireless devices, wherein the other wireless devices are in close proximity and capable of appending their displays to create a larger display area.

8. The apparatus of claim 7, further comprising a synchronization manager to reconcile user interactions, provide synchronization between window managers for each of the displays, and provide a unified window stacking order.

9. A method comprising:
storing application window regions of applications running on a wireless device in memory; and
generating a composite display from at least some of the application window regions stored in the memory and any application window regions received from other wireless devices.

10. The method of claim 9, further comprising transmitting display information regarding at least some of the application window regions stored in the memory to the other wireless devices.

11. The method of claim 9, further comprising
storing the composite display in a frame buffer; and
displaying the composite display stored in the frame buffer on a display.

12. The method of claim 9, further comprising establishing wireless communication links with the other wireless devices.

13. The method of claim 9, further comprising detecting the other wireless devices.

14. The method of claim 9, further comprising receiving display information regarding application window regions from the other wireless devices that are in close proximity and capable of appending their displays to create a larger display area.

15. A wireless device comprising:
a display;
at least one application to generate content;
memory to store application window regions of the at least one application;
a composite display generator to generate a composite display based on at least some of the application window regions stored in the memory and any display information regarding application window regions received from other wireless devices; and
a remote display protocol to transmit display information regarding at least some of the application window regions stored in the memory to the other wireless devices, wherein the other wireless devices are in close proximity to the wireless device and capable of appending their displays with the display to create a larger display area.

16. The wireless device of claim 15, further comprising a synchronization manager to reconcile user interactions.

17. The wireless device of claim 15, further comprising a synchronization manager to provide synchronization between window managers for each of the displays and provide a unified window stacking order.

18. The wireless device of claim 15, further comprising a communication interface to establish wireless communication links with one or more or more other wireless devices having displays.

19. The wireless device of claim 15, wherein the display information includes pixels representing the application window regions.

20. The wireless device of claim 15, wherein the display information includes commands necessary to generate pixels representing the application window regions.
